(19) United States
(12) Patent Application Publication
(10) Pub. No.: US 2016/0257520 A1
(43) Pub. Date: Sep. 8, 2016

(54) CUTTING BLADE OF A SHEET DISPENSER

(71) Applicant: ACHTON SPAIN SL, Alicante (ES)

(72) Inventor: Kim Achton, Farevejle (DK)

(73) Assignee: Achton Spain SL, Alicante (ES)

(21) Appl. No.: 15/029,151

(22) PCT Filed: Oct. 15, 2013
(86) PCT No.: PCT/EP2013/071504

§ 371 Date: Apr. 13, 2016

(51) Int. Cl. B65H 35/00; B65H 16/00; B26D 1/00

(52) U.S. Cl. CPC B65H 35/0086; B26D 1/0006; B65H 16/005; B26D 2001/0026

(57) ABSTRACT

The present invention concerns a cutting blade for cutting web material in to sheets in a sheet dispenser. The blade comprises at least a base section and a cutting section, the blade being formed from a plastic material which comprises reinforcement fibers. The present invention also concerns a sheet dispenser having such a cutting blade.

### FIELD OF THE INVENTION

The present invention relates to a cutting blade of a paper dispenser. More specifically, the present invention concerns a cutting blade having a novel composition providing enhanced cutting properties. The present invention also concerns a dispenser having such a cutting blade.

### PRIOR ART

Many different types of dispensers are known for dispensing a sheet to a user from a continuous web. At the simplest, such a dispenser may consist of a frame for holding a web roll and a blade for tearing of a sheet from the web. More advanced dispenser arrangements comprise dispensing mechanisms of various kinds. A particularly widespread dispensing mechanism type comprises a dispensing drum around which the web runs. The dispensing drum has an axial slot on its circumference, from which slot a cutting blade is arranged to extend and retract once per each revolution.

An example of a dispensing mechanism having a cutting blade reciprocally protruding and extracting from a dispensing drum is described in U.S. Pat. No. 4,712,461.

Regardless of the type of the dispensing mechanism, a common component in dispensers dispensing sheets cut from a web, is the blade that is used for cutting, either by the user tearing the web against the blade, or by a mechanism of the dispenser. Such a blade must be rigid enough to withstand the cutting forces exerted on it, and sharp enough for providing reliable cutting action. In order to facilitate such properties, a typical blade comprises at least a cutting section, which is often sharp and/or serrated, and a sufficiently rigid base section, from which the blade is mounted to the dispenser. Depending on the type of the dispenser, the blade may additionally comprise other sections, for example, joint surfaces and a pivot cam. Naturally, a blade must remain sharp and resist wear and tear. In order to provide sufficient wear-resistance the base section and the cutting section of the blade are often manufactured from different materials and subsequently assembled together.

However, a long felt need in producing sheet dispensers has been to simplify both part manufacturing and assembly of the dispensers. This has led to the tendency of manufacturing as many components as possible from a single material in a single manufacturing process.

In the particular case of a cutting blade, using metal as a manufacturing material provides good cutting properties, but is rather uneconomical due to the complex forms required from a cutting blade used in more advanced dispensing mechanisms. Plastic materials, on the other hand, provide good possibilities for simplifying components by combining parts and forms into simpler molded parts, but plastic materials lack the desired cutting properties due to rapid wear of the cutting section of the blade. Efforts have been made to combine a cutting section made from metal to a base section made from a plastic material. However, such arrangements require separate steps for the manufacturing both the base section and the cutting section in addition to assembling these two together.

### SUMMARY OF THE INVENTION

It is an object of the present invention to provide a cutting blade that is simple to manufacture, rigid, and maintains its cutting abilities even under heavy use.

This object is achieved by providing a cutting blade from a plastic material comprising reinforcement fibers. The reinforcement fibers provide the required rigidness for the blade to withstand cutting forces. Additionally, as the blade is used, the reinforcement fibers of the plastic material emerge from the worn cutting section. The reinforcement fibers protruding from the worn cutting section provide a coarse microstructure at the cutting section, thus enhancing the cutting properties of the worn blade. The reinforcement fibers also help the cutting section to maintain its intended form under wear.

### DETAILED DESCRIPTION OF THE INVENTION

In an embodiment according to the invention, a cutting blade is fowled from plastic, e.g. by injection molding. Said blade comprises a base section suitable for mounting the cutting blade to a dispenser, and a cutting section suitable for cutting a web material in to sheets. Advantageously the cutting section comprises sharp serrated tips projecting from the base section. Depending of the type of the dispenser, to which the cutting blade is intended to be mounted, the cutting blade may comprise sections enabling attachment to, and/or actuation by a dispensing mechanism. The plastic used to form the cutting blade comprises reinforcement fibers. Although other types of particles are known to be used for reinforcing plastic, only reinforcement fibers provide improved cutting properties, as described hereafter.

The presence of the reinforcement fibers in plastic used to form the cutting blade has been found to enhance several properties of the cutting blade. Because the cutting blade is reinforced, it becomes more rigid, thus being more capable of withstanding the cutting forces exerted on it. As the blade yields less during the cutting action, the piercing and cutting of the web material is improved. When the blade is formed, its surface forms a substantially uniform sealed surface. As the cutting section of the blade wears during use, the reinforcement fibers are revealed from under the sealed surface. The ends of the reinforcement fibers protruding from the worn cutting section form a coarse microstructure enhancing the cutting properties of the worn blade even further. In addition to this, the reinforcement fibers prevent the matrix, i.e. the plastic component of the blade, from being worn out of the intended shape. That is, the actual cutting section remains in a sharp form for longer.

The plastic material used to form the cutting blade comprises preferably at least 20%, more preferably at least 30%, most preferably at least approximately 40% of reinforcement fibers by volume. Correspondingly, the plastic material used to form the cutting blade comprises preferably no more than 80%, more preferably no more than 65%, most preferably no more than approximately 40% of reinforcement fibers by volume. If the plastic material comprises too little of reinforcement fibers, the blade does not maintain its cutting properties when worn. On the other hand, if the plastic comprises too much reinforcement fibers, a sufficient matrix isn't formed to bind the reinforcement fibers together.

Advantageously, the reinforcement fibers are uniformly distributed within the cutting blade. This ensures that as the cutting section of the blade is worn, there is a sufficient amount of reinforcement fibers emerging from under the worn surface for providing improved cutting properties as discussed above. The reinforcement fibers are advantageously randomly oriented within said cutting blade. This, in turn, ensures that as the cutting section of the blade is worn, a sufficient amount of reinforcement fibers protrude from the worn cutting section in order to create a desired coarse microstructure.

Any reinforcement fiber commonly used for reinforcing plastics may be used for manufacturing a cutting blade according to the present invention. Examples of such fibers are aramid, carbon, mineral, glass, etc. Glass fibers are, however, found to be particularly suitable to be used in manufacturing the cutting blade.

Other recognized factors relevant for providing improved cutting properties are the hardness and the type of the used plastic. If the used plastic is too soft, the cutting blade wears out too rapidly. On the other hand, if the plastic is too hard, the plastic matrix of the cutting section may not wear in a suitable way for the reinforcement fibers to emerge from beneath the worn cutting section. Advantageously the used plastics has a Rockwell M-scale hardness of preferably at least 70 HRM, more preferably at least 85 HRM, most preferably at least 100 HRM. A particularly suitable hardness for the plastic material has found to be approximately 100 HRM. Any suitable plastic may be used for forming the cutting blade. For example, the used plastic may be chosen from the group comprising PA, PES, PC and PPS. It has also been found that PPS is particularly advantageous for the cutting properties and manufacturing of the blade.

According to an embodiment of the invention, the cutting blade is formed as a single piece. This enables simplifying the manufacturing and assembly process of the cutting blade, and further the dispenser in which the cutting blade is used.

A cutting blade according to the invention is most suitably fitted in a sheet dispenser, which generally comprises at least a body for holding web material. Advantageously, the sheet dispenser comprises a dispensing mechanism that actuates said cutting blade in order to cut sheets from the web material. In such a solution, the benefits of a cutting blade according to the present invention become more apparent, as a more complex structure is required from the cutting blade.

1. A cutting blade for cutting web material into sheets in a sheet dispenser, said blade comprising a base section and a cutting section, wherein said blade is formed from a plastic material, characterized in that said plastic material comprises reinforcement fibers.

2. A cutting blade according to claim 1, wherein said plastic material comprises preferably at least 20%, more preferably at least 30%, most preferably at least approximately 40% of reinforcement fibers by volume.

3. A cutting blade according to claim 1, wherein said plastic material comprises preferably no more than 80%, more preferably no more than 65%, most preferably no more than approximately 40% of reinforcement fibers by volume.

4. A cutting blade according to claim 1, wherein said reinforcement fibers are uniformly distributed.

5. A cutting blade according to claim 1, wherein said reinforcement fibers are randomly oriented.

6. A cutting blade according to claim 1, wherein said reinforcement fibers are selected from the group consisting of aramid, carbon, mineral and glass fibers.

7. A cutting blade according to claim 1, wherein said plastic material has a Rockwell M-scale hardness of preferably at least 70 HRM, more preferably at least 85 HRM, most preferably at least 100 HRM.

8. A cutting blade according to claim 1, wherein said plastic material is selected from the group consisting of PA, PES, PC and PPS.

9. A cutting blade according to claim 1, wherein said cutting blade is formed in a single piece.

10. A sheet dispenser for dispensing sheets of a web material comprising a body for holding said web material, and a cutting blade having a base section and a cutting section, wherein said blade is formed from a plastic material, characterized in that said plastic material comprises reinforcement fibers.

11. A sheet dispenser according to claim 10, wherein said sheet dispenser further comprises a dispensing mechanism that actuates said cutting blade in order to cut sheets from said web material.

12. A cutting blade according to claim 1, wherein said plastic material comprises at least 20% of reinforcement fibers by volume and wherein said plastic material has a Rockwell M-scale hardness of preferably at least 70 HRM.

13. A cutting blade according to claim 1, wherein said plastic material comprises at least approximately 40% of reinforcement fibers by volume and wherein said plastic material comprises no more than approximately 40% of reinforcement fibers by volume.

14. A cutting blade according to claim 1, wherein said plastic material comprises at least 20% of reinforcement fibers by volume, wherein said plastic material has a Rockwell M-scale hardness of preferably at least 70 HRM, and wherein said plastic material comprises no more than approximately 40% of reinforcement fibers by volume.

15. A cutting blade according to claim 1, wherein said reinforcement fibers are uniformly distributed and randomly oriented and are selected from the group consisting of aramid, carbon, mineral and glass fibers.

16. A cutting blade according to claim 1, wherein said plastic material has a Rockwell M-scale hardness of preferably at least 70 HRM and wherein said plastic material is selected from the group consisting of PA, PES, PC and PPS.

17. A cutting blade according to claim 1, wherein said reinforcement fibers are selected from the group consisting of aramid, carbon, mineral and glass fibers and said plastic material is selected from the group consisting of PA, PES, PC and PPS.

18. A cutting blade according to claim 1, wherein said plastic material comprises no more than 80% of reinforcement fibers by volume and wherein said plastic material has a Rockwell M-scale hardness of preferably at least 70 HRM.

19. A cutting blade for cutting web material into sheets in a sheet dispenser, said blade comprising a base section and a cutting section formed in a single piece from a plastic material comprising reinforcement fibers
wherein said plastic material comprises at least 20% of reinforcement fibers by volume and no more than 80% of reinforcement fibers by volume,
wherein said reinforcement fibers are selected from the group consisting of aramid, carbon, mineral and glass fibers and are uniformly distributed and randomly oriented,
wherein said plastic material is selected from the group consisting of PA, PES, PC and PPS and has a Rockwell M-scale hardness of at least 70 HRM.

20. A cutting blade as claimed in claim 19 wherein said plastic material comprises at least 40% of reinforcement fibers by volume and no more than 65% of reinforcement fibers by volume, and wherein said plastic material has a Rockwell M-scale hardness of at least 100 HRM.
